(19) United States
(12) Patent Application Publication
(10) Pub. No.: US 2003/0004998 A1
(43) Pub. Date: Jan. 2, 2003

(54) Proxy-based acceleration of dynamically generated content

(75) Inventor: Anindya Datta, Atlanta, GA (US)

Correspondence Address: KING & SPALDING, 191 PEACHTREE STREET, N.E., ATLANTA, GA, 30303-1763, US

(73) Assignee: Chutney Technologies, Inc., Atlanta, GA

(21) Appl. No.: 10/067,432

(22) Filed: Feb. 4, 2002

Related U.S. Application Data
(60) Provisional application No. 60/302,122, filed on Jun. 29, 2001.

(51) Int. Cl. G06F 15/00

(52) U.S. Cl. 707/513

(57) ABSTRACT

A system and method for delivering a web page can include receiving a web page request corresponding to a web page having cacheable content. In response to the web page request, a script can be executed to produce a template of the web page at run-time. The script can include a code block corresponding to a cacheable content fragment of the web page. A key identifying the cacheable content fragment can be inserted into the template. The template can be sent to a dynamic proxy cache. The dynamic proxy cache can insert the cacheable content fragment identified by the key into the web page. The web page including the cacheable content fragment can then be delivered to a user.

### PRIORITY AND RELATED APPLICATIONS

This application claims the benefit of priority to U.S. Provisional Patent Application Serial No. 60/302,122, entitled “Front-End Acceleration of Dynamically Generated Content,” filed Jun. 29, 2001. This application is related to U.S. Non-Provisional Patent Application Serial No. 09/722,260, entitled “Dynamic Page Generation Acceleration Using Component-Level Caching,” filed Nov. 24, 2000. The disclosure of the priority document and the related document is hereby fully incorporated by reference.

### FIELD OF THE INVENTION

The present invention relates generally to delivering web pages over the Internet. More particularly, the present invention relates to caching web page fragments to enable improved web page delivery speeds and web site scalability.

### BACKGROUND OF THE INVENTION

A critical issue in conducting commerce via the Internet (“e-commerce”) is scalability. Scalability refers to the ability of a web site to deliver web pages in a timely manner in high traffic situations and the ability of the web site to respond appropriately when traffic increases significantly. A web site must provide fast response times even under heavy user loads during heavy traffic periods. Web site response times can be measured by web page delivery speed during those heavy traffic periods.

E-commerce has experienced phenomenal growth during the past few years. That upward trend is expected to continue for years to come. Some predictions claim that e-commerce revenues will continue to grow and will exceed $1.3 trillion by 2003. That growth in revenue has produced, and will continue to produce, an increase in web traffic. As the number of Internet customers increases, an e-commerce company must simultaneously deliver web pages to tens of thousands of customers. That requirement can place a great strain on the computing resources of the company. With the current state of Internet infrastructure technology supporting web site traffic, e-commerce web sites are having trouble supporting such extreme growth while maintaining an acceptable level of service.

In the past, e-commerce companies typically served static content for their web pages. Static content is content that does not change over its lifetime and that can be stored and served from “ready-made” files. Over the past few years, e-commerce companies have transitioned from the static content model to a dynamic content model. In the dynamic content model, content is generated and served “on-demand.” By generating the content on-demand, the e-commerce company can customize its web page according to an individual user's preferences, in response to a set of parameters associated with that user. The parameters can include information related to the user's buying habits or Internet browsing behavior. For example, based on the user's parameters, the web page can display the individual user's preferred stock quotes and a personal greeting.

Another example of dynamic web page generation involves the promotion of related products. For instance, a customer at an online book website may travel down the web page link path: Fiction-Thriller-Legal Thriller. If it is known (for example, through accumulating empirical Internet browsing behavior data) that customers who travel down that link path are statistically likely to also be interested in jazz music, then the next web page presented to the customer can have a component including a reference to jazz music.

Accordingly, dynamic web pages enable the delivery of tailored information to a customer. However, dynamic web pages generate a unique web page for different users based on the particular user's set of parameters. Creating unique web pages for individual users creates additional requirements on computing resources and contributes further to the difficulty of maintaining an acceptable level of service.

Today, many web sites delivering dynamic web pages unique to different users experience significant performance problems in terms of response times. Poor performance can be detrimental to a web site's ability to successfully conduct commerce online. One measurement of response times is the time to deliver a complete web page to a customer. Unacceptable web page delivery delays are a known cause for customer abandonment (a form of customer attrition). One study predicts that if a web page requires longer than eight seconds to deliver, then 30% of customers will abandon the web page request. Another study estimates that a one second improvement in page loading time (for example, from 6.30 seconds to 5.30 seconds) can reduce the abandonment rate from 30 percent to about 7 percent. Other studies indicate that customer attrition attributable to abandonment may cost the online business community upwards of $100 million per month.

Many e-commerce companies are increasingly adopting dynamic page generation technologies to dynamically display content. However, as discussed above, dynamic page generation comes with a cost. Web and application server scalability can be significantly reduced when dynamically generating web pages, because the web pages are generated on-demand, rather than served from files on disk or in memory. Accordingly, the load on the web and application servers increases to retrieve and format the requested content. Consequently, even under moderate traffic loads, web page generation times slow down significantly.

Web sites typically utilize application servers to dynamically generate Hypertext Markup Language (HTML) pages. Application servers execute scripts to generate (or create) the dynamic web pages. The scripts typically perform a significant amount of work to generate a dynamic web page. For example, the script may require the application server to retrieve web page content from database systems (located locally or remotely), to perform content transformations (for example, from XML to HTML) (XML is an acronym for Extensible Markup Language), and to execute other business logic (for example, personalization logic). In the absence of web page caching (storing), each request for a dynamic web page requires the entire script to be executed. When the same web page content is requested and generated repeatedly, an unnecessary load on the application server results, leading to longer (and often unacceptable) response times for site visitors.

To reduce the overhead associated with dynamic web page generation, web pages (or portions of web pages) may be cached in a main memory. When a web page is cached, content generated for one user is saved and used to serve subsequent requests for the same content. Two conventional caching-based approaches exist for improving the performance of web content distribution and delivery. Those two approaches are proxy-based (front-end) caching and back-end caching.

Proxy-based caches are based on caching content outside the web site's infrastructure. The content can include static content such as media files (for example, pictures, audio, or video) or dynamically generated HTML pages. These types of caches are considered a front-end caching solution since they reside outside of the web site's infrastructure, typically in front of the web server cluster and outside the firewall. Proxy-based caches can provide significant bandwidth savings by relieving the web site's infrastructure from the work required to push responses through the site. (Bandwidth is the capacity needed to transmit a certain amount of data in a fixed amount of time. For digital devices, bandwidth is typically expressed in bits per second (bps) or bytes second.)

Two types of proxy-based caches exist. The first type of proxy-based cache is a page-level cache. A page-level cache stores an entire web page of dynamically generated content. Thus, a page level cache stores content at the granularity of a full web page. Page level caches can improve web site performance by reducing (a) delays associated with generating the content, (b) delays associated with packet filtering and other firewall-related delays and (c) delays associated with transmitting the content through the site infrastructure.

However, three limitations are associated with using page-level caching solutions to cache dynamic pages. First, page level caching solutions rely on the request URLs (Uniform Resource Locators) to identify pages in cache. When pages are dynamically generated, different invocations of a given script, even with the same input parameters, are not guaranteed to produce the same page. Accordingly, the same URL request can generate different pages for different users. For example, if a web page is initially generated based on a set of parameters for one user and then cached, subsequent requests for that web page by a different user having a different set of parameters will result in the initial web page being delivered. Thus, a proxy-based, page-level cache may serve incorrect pages. This problem has previously prevented the use of proxies in caching dynamic pages.

Another limitation of page-level solutions is that full HTML pages are typically not reusable. For example, web sites that serve highly personalized pages may include a customer greeting on every page. Accordingly, every page instance is unique and is reusable only if the same user makes the same request. This problem can lead to low hit ratios for a cached page, negating any benefit of caching the page.

Page-level caching also causes unnecessary invalidation of cached web pages. If only one or a few elements on a page become invalid, then the entire page becomes invalid. Accordingly, some page elements are regenerated more frequently than the frequency in which they change.

A second type of proxy-based caching is dynamic page assembly. In dynamic page assembly, a template is established for each dynamically generated web page. The template specifies the content and layout of the page using a set of markup tags. Essentially, each page is factored into a number of fragments (specifically, separate dynamic scripts) that are used to assemble the page at a network cache when the page is requested. Content generated from templates and factored fragments are cacheable as separate HTML files on distributed caching architectures. Responses can then be assembled at the distributed caching locations around the Internet, rather than accessing the origin server. By moving the dynamic content closer to the user, many of the same benefits of page-level caching accrue, with the additional benefit of further reduced response times and network bandwidth requirements. Those benefits are obtained because the origin web site does not have to deliver the content.

There are two limitations associated with the conventional dynamic page assembly approach. One limitation is the requirement that a site follow a specified page design paradigm. The paradigm is the use of specified templates, which in turn call separate dynamic scripts for each dynamically generated fragment. The use of templates requires that page layout be known in advance. For example, users having different sets of parameters may generate different page layouts. The page for one user could be factored into, for example, a template plus five fragments, while the page for another user could be factored into, for example, a template plus four fragments. These caches base response decisions on the requested URL. Accordingly, once the template and fragments for one of the two users are present in the cache, every subsequent request for the same URL will be served from cache, regardless of which user makes the request. Thus, sites supporting dynamic layouts cannot take advantage of dynamic page assembly. Additionally, the use of cached templates and fragments is a major departure from the standard Model-View-Controller design paradigm used in many web sites and may require redesigning and rebuilding a web site from the ground up.

Another limitation of the dynamic page assembly approach is that it cannot be used in the context of pages with semantically interdependent fragments. If dependencies between the fragments of a page exist, then scripts from different fragments repeat the same operation to generate a single page. Accordingly, significant repetition of work is performed on the site when separate fragments include the same steps in their respective scripts. Thus, dynamic page assembly is optimal only for pages that can be easily decomposed into a small number of static, independent fragments, and where the overall layout of the page does not change.

The second approach for improving the performance of web content distribution and delivery is back-end caching. Back-end caching approaches cache content at the various layers within the web site's architecture. Back-end caching approaches can help reduce the delays associated with generating content. These solutions can provide the correct content in a generated page because they do not rely on URLs and because they can observe all script parameters at the back end. Back-end caching typically involves finer granularities than page-level caching, allowing greater reuse of content and fine-grained invalidation. However, a limitation of back-end caching approaches is the delivery of all content from the dynamic content application itself. Accordingly, back-end caching does not reduce the bandwidth needed to connect to the server to obtain the content, and it does not address network-related delays. In other words, it does not address delays resulting from transmitting high-bandwidth content through the web site and Internet infrastructures (for example, firewall processing delays and routing delays).

Therefore, given the extreme growth in Internet traffic, as well as the increasing use of dynamic page generation technologies, there is a need in the art to improve web and application server scalability. There is a further need in the art for a cache-based approach that mitigates delays associated with dynamic content creation, distribution, and delivery over the Internet.

### SUMMARY OF THE INVENTION

The present invention can provide the ability to cache dynamic content at finer granularities outside a web site's infrastructure. Accordingly, the present invention can provide the benefits of caching finer granularities of content (for example, greater content reusability), while simultaneously achieving the benefits associated with proxy-based caching (for example, reduced bandwidth and reduced firewall processing). The present invention can provide a system and method that combines the benefits of both proxy-based caching and back-end caching, while overcoming the drawbacks of those conventional approaches.

The present invention can provide a back end monitor as part of a web site's infrastructure. The back end monitor can observe web page script execution by the web site's application server. A template of the web page can be generated by the back end monitor based on observed web script execution patterns. The template according to an exemplary embodiment of the present invention can include a key referencing cacheable content stored in a dynamic proxy cache outside of the web site's infrastructure. The dynamic proxy cache can receive the template and can assemble the web page as instructed in the template. The dynamic proxy cache can then forward the web page to a user.

As stated above, the template produced according to an exemplary embodiment of the present invention can include a key referencing a cacheable content fragment stored in the dynamic proxy cache. A “get” command in the template can instruct the dynamic proxy cache to retrieve the cacheable content fragment and to insert it into the web page.

If the cacheable content fragment is not stored in the dynamic proxy cache, then the template can include the cacheable content fragment and the key referencing that fragment. A “set” command in the template can instruct the dynamic proxy cache to store the cacheable content fragment and its key. The dynamic proxy cache can insert the cacheable content fragment into the web page before or after storing that fragment in its memory. Accordingly, the cacheable content fragment can be made available in the dynamic proxy cache for subsequent web page requests including that fragment.

The back end monitor of an exemplary embodiment of the present invention can track content fragments stored in the dynamic proxy cache. A cache directory in the back end monitor can include a listing of the keys referencing the content fragments stored in the dynamic proxy cache. The back end monitor can search the cache directory for a particular content fragment's ID and associated key to determine whether the particular content fragment is stored in the dynamic proxy cache. The back end monitor also can monitor the content fragments and can delete invalid fragments from the cache directory. Accordingly, the key associated with the invalid content fragment can be made available for future use. The back end monitor also can send a removal message to the dynamic proxy cache, instructing it to remove an invalid content fragment.

According to an exemplary embodiment of the present invention, a method for delivering a web page can include receiving a web page request for a web page having cacheable content. In response to the web page request, a script can be executed to produce a template of the web page. The script can include a code block corresponding to a content fragment of the web page. If the content fragment is cacheable, then a key referencing the cacheable content fragment can be inserted into the template. The template can be sent to a dynamic proxy cache outside of the web site's infrastructure. The dynamic proxy cache can insert the cacheable content fragment identified by the key into the web page. The web page including the cacheable content fragment can then be delivered to a user.

Another exemplary embodiment of the present invention relates to a web page delivery system for dynamically generating a web page including cacheable content. The system can include origin web site infrastructure having an application server and a back end monitor. The application server can be operative to receive a web page request from a user, to generate a web page template, and to forward the template for creation of the web page. The back end monitor can be operative to insert a key referencing a cacheable content fragment into the template. The system also can include a dynamic proxy cache operative to receive the template from the application server, to create the web page by inserting the cacheable content fragment, and to deliver the web page to the user.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a block diagram depicting a conventional architecture of a web site employing dynamic content generation technologies for generating web pages.

FIGS. 2A and 2B are simplified block diagrams of exemplary web pages having dynamic content.

FIGS. 2C and 2D are simplified schematics of the layout of the exemplary web pages depicted in FIGS. 2A and 2B, respectively.

FIG. 3A is a block diagram depicting a network architecture according to an exemplary embodiment of the present invention.

FIG. 3B is a block diagram depicting a network architecture showing alternative locations of a dynamic proxy cache according to exemplary embodiments of the present invention.

FIG. 3C is a block diagram depicting a process of operation of a web site architecture according to an exemplary embodiment of the present invention.

FIG. 4 is a flow chart depicting a method for application server processing according to an exemplary embodiment of the present invention.

FIG. 5 is a flow chart depicting a method for web page assembly according to an exemplary embodiment of the present invention.

FIG. 6 is a block diagram depicting an exemplary script and the corresponding web page that the script can generate.

FIG. 7 is a block diagram depicting the script of FIG. 6 associated with code block tags according to an exemplary embodiment of the present invention.

FIG. 8 illustrates a web page template according to an exemplary embodiment of the present invention that can be generated by an application server for the initial execution of a script.

FIG. 9 illustrates a web page template according to an exemplary embodiment of the present invention that can be generated by an application server for subsequent execution of the script.

FIG. 10 is a flow chart depicting a method for application server processing according to another exemplary embodiment of the present invention.

FIG. 11 is a block diagram depicting an exemplary script and a corresponding web page that the script can generate.

FIG. 12 is a block diagram depicting the script of FIG. 11 associated with code block tags according to an exemplary embodiment of the present invention.

FIG. 13 illustrates a web page template according to an exemplary embodiment of the present invention that can be generated by an application server for the initial execution of a script.

FIG. 14 illustrates a web page template according to an exemplary embodiment of the present invention that can be generated by an application server for subsequent execution of the script.

FIG. 15 is a flow chart depicting a method for cache directory key assignment according to an exemplary embodiment of the present invention.

FIG. 16 is a flow chart depicting a method for cache directory key assignment according to an exemplary embodiment of the present invention including more than one dynamic proxy cache.

FIG. 17 is a flow chart depicting a method for cache directory key removal according to an exemplary embodiment of the present invention.

### DETAILED DESCRIPTION OF EXEMPLARY EMBODIMENTS

Exemplary embodiments of the present invention will be described in detail with reference to the accompanying drawings in which like reference numerals represent like elements.

The Scalability Problem

Web page delivery performance is a critical success factor for e-commerce. The performance of a web site is determined by its ability to scale. Not only must a site be able to provide fast response times (for example, web page delivery speed), but also it must be able to do so even under heavy user loads (for example, high user traffic). Scalability refers to the ability of a web site to deliver web pages in a timely manner in high traffic situations and the ability of the web site to respond appropriately when traffic increases significantly. Thus, scalability is a critical problem for e-commerce sites. An exemplary embodiment of the present invention defines a novel and unique dynamic web page component caching model that improves the scalability of web and application servers.

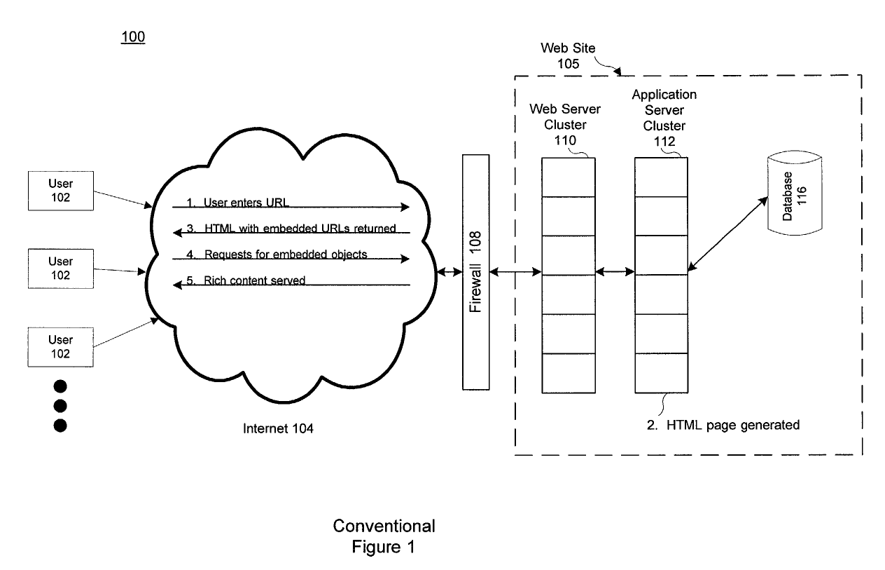

FIG. 1 is a block diagram depicting a conventional architecture 100 of a web site employing dynamic content generation technologies for generating web pages. A web page typically consists of text and several embedded objects such as graphics. A web page can be thought of as a set of components (or content elements or content fragments), where a component is a group of data representing a displayable element. FIG. 1 also depicts the steps required to satisfy a user's request for a web page over the Internet. As shown in FIG. 1, the exemplary web page download process includes four-steps. A user 102 typically uses a local computer to connect to a web site 105 via the Internet 104. A firewall 108 controls the data that enters the web site 105. When user 102 first requests a web page, the user's web browser sends a web page request, including the URL for the location of the script that will generate the requested page (step 1). The request travels over Internet 104, through firewall 108, and to a web server 110 of web site 105. Web server 110 passes the request on to an application server 112, which executes the script that generates the page (step 2). Application server 112 is connected to a content database 116 either directly or via Internet 104 (or some other network). Content database 116 can have content elements accessible by application server 112 to construct the requested page. The content request is contained in the web page request sent to web site 105.

When application server 112 executes the script to generate the web page, the content (for example, HTML) corresponding to the requested page is generated, along with the URLs for the embedded objects in the page. Accordingly, additional work on the part of application server 112 is needed to retrieve and format the requested content. For example, content is typically retrieved from underlying database systems, such as content database 116, which may be located remotely. Once the content is retrieved, additional steps may be required to format the content (for example, content stored as XML must be rendered as HTML). In short, application server 112, upon receipt of the user's request, performs significant work and outputs the HTML that is sent back to the user (step 3). The HTML typically includes several embedded references to rich content objects, such as images. Those objects must be retrieved separately (steps 4 and 5).

After user 102 receives the server output (step 3), the user's browser initiates subsequent requests for the embedded objects (step 4) (browsers differ in the number of objects they can retrieve per request). Those objects are often located on web server 110. However, those objects may be located at other sites. Application server 112 returns the objects to the user over the Internet (step 5). That last step can be consumptive of network resources, requiring more time to download. Pages having a large number of embedded objects can have significantly longer download times. Moreover, the traffic between the client and the server must go through an extensive network of transmission and switching devices such as routers, switches, and firewalls. Thus, the communication between user 102, application server 112, and any involved content database 116 (or other database) can be extremely consumptive of time and computing resources.

Given the above-identified steps involved in downloading a web page, a number of potential bottlenecks can be identified. These bottlenecks can be classified into four broad areas:

1. low bandwidth at the user and/or web server/application server ends,

2. page generation latency,

3. fetching embedded objects, and

4. redundant connections to serve the same objects.

Each of these types of delay is next described in more detail.

Delays due to low bandwidth concern network speeds. Since the Internet backbone is high-speed, bandwidth problems occur primarily in the “first mile” at the web server and/or in the “last mile” at the user's end. In the past, modem speeds limited the ability to achieve fast Internet access speeds and contributed to slow download times. However, the advent of higher bandwidth access technology, such as broadband modems, has significantly improved that problem in the last mile at the user's end. While the bandwidth issue has also improved in the first mile (i.e., between the origin site web server and the internet service provider), there is still room for improvement as demand for content continues to increase rapidly.

Delays associated with page generation latency are caused by the work required by application server 112 to deliver the requested content. That type of delay occurs between steps 1 and 3 in FIG. 1. The page generation latency component was not considered to be a significant problem until very recently, because web sites 105 traditionally responded by transmitting a static HTML page to user 102. With the increasingly widespread use of dynamic page generation technologies, page generation latency has become a critical issue. The amount of work required of web server 110 and application server 112 continues to increase. Page generation latency delays include the delays due to retrieving content from persistent file systems such as content database 116 (both local and remote), the delays due to web server's 110 and application server's 112 formatting of the content elements, and the delays due to business logic execution (for example, personalization logic).

Fetching embedded objects (step 4) incurs additional network delay. Typically, user 102 and application server 112 are separated by long distances. Embedded objects that are requested must be downloaded over these long distances. Accordingly, delays occur because these large pieces of data move relatively slowly due to the switching required to make a connection over a significant distance. Solutions to that problem are available and generally involve an attempt to ameliorate those delays by storing data (for example, embedded objects) closer to end users (for example, storing rich content objects on servers that are physically located closer to end users). That approach reduces the travel distance required for content delivery and decreases the number of connections required to transmit content from content providers to end users.

Another problem arises when redundant connections are made to serve the same objects. Each page request typically goes through a router, a firewall, and a switch before reaching web server 110 and then application server 112. Application server 112 then processes the request and passes it back through the same network components. Because each of those devices has a finite throughput, forcing each request through those devices can cause scalability problems. Furthermore, as more and more users try to access the same content, the redundant load on the firewalls and servers for the same embedded objects increases. The problem of redundant connections affects requests for objects including static content, dynamic content, or both.

Various solutions to the redundant connection problem for static content are available. Generally, such solutions involve attempts to reduce the number of redundant connections for the same static object by caching the object. Caching reduces the load on the origin server, thereby helping to solve the redundant connections problem for static content. Additionally, web sites are increasingly using dynamic page generation technologies to generate content on demand. As the use of dynamic objects increases, the requests for redundant, static objects will decrease. Accordingly, the problem of redundant connections for static content will also decrease. However, the problem of redundant connections for dynamic content is not solved by the current solutions discussed above.

The present invention can address the bandwidth problem, the redundant connections problem, and the page generation latency problem. The present invention can reduce the bandwidth needed from the content provider to the edge server to process a web page request. Redundant connections for dynamic content also can be reduced by the present invention. Finally, the present invention can reduce the page generation load on an application server, as discussed more fully below.

The Page Generation Latency Problem

Web page generation latency is a significant problem that in many cases is the primary impediment to efficient web page generation and delivery. The problem of page generation latency concerns the delays associated with generating pages at the application server 112. That problem, while significant, has only recently been addressed. However, existing solutions are point solutions and do not address many of the specific delays associated with page generation.

In addition to pure script execution overhead, which itself can be non-trivial under moderate to heavy traffic load, there are several other types of delay associated with generating dynamic pages. Those types of delay are described below in more detail.

One kind of page generation delay is caused by fetching content from persistent storage. That kind of delay is primarily attributable to the need to retrieve data stored on a disk, which is a relatively slow operation. That delay can be further classified according to the two types of access required: a) local database access, and b) remote database access. Both types of access to database systems incur input/output (I/O) delay. Access to remote database systems is even more costly as it incurs network delay in addition to I/O delay.

Another kind of page generation delay is caused by the need to perform data transformations. Given the overwhelming acceptance of XML as a medium of exchange and as a means of characterizing content, web sites are increasingly maintaining content in XML format. However, since XML alone cannot be presented in a meaningful way, there is a need to separate the content and presentation aspects of a web page. That separation is made possible by the use of XSLT (Extensible Stylesheet Language Transformations), a language used to transform an XML document into some other specified format (for example, HTML text). A number of vendors offer XSLT processors that perform such transformations. The XML to HTML transformation process increases the load on the server, because it involves parsing and other string-processing operations.

Yet another kind of page generation delay is caused by the need to execute business logic. Web sites commonly incorporate business logic into their scripts. For example, many e-commerce sites utilize personalization software to deliver targeted content to site visitors. The business logic further increases the load on web and application servers as well as on the underlying databases.

Solutions that explicitly address dynamic page generation processing delays from a global perspective are not currently available. Rather, only point solutions exist. For example, some caching can be done by a database management system (DBMS) (especially with the advent of main memory database systems) or the web and application servers, but that caching does not mitigate the problem of accessing remote databases, nor does it address the problem of data transformations. Moreover, given that I/O times have reduced by a factor of only 2.5 times during the last decade (as opposed to network latencies, which have reduced by a factor of 106), the problem of I/O delay is a legitimate concern. The problem of page generation latency itself is new, and is a result of the introduction and rapid deployment of dynamic page generation technologies. In many cases, page generation bottlenecks become the dominant impediment to efficient dynamic web page generation and thus to the overall scalability of the site. While the conventional approach is to buy more hardware and software, that approach is not an attractive alternative in terms of cost and is often an infeasible solution in the long run.

To solve that problem, an exemplary embodiment of the present invention provides a dynamic proxy cache that caches dynamic web page fragments away from the web site's infrastructure, thereby significantly reducing the page generation load on the application server. The present invention also can result in a significant reduction in bandwidth requirements.

Dynamic Page Layouts

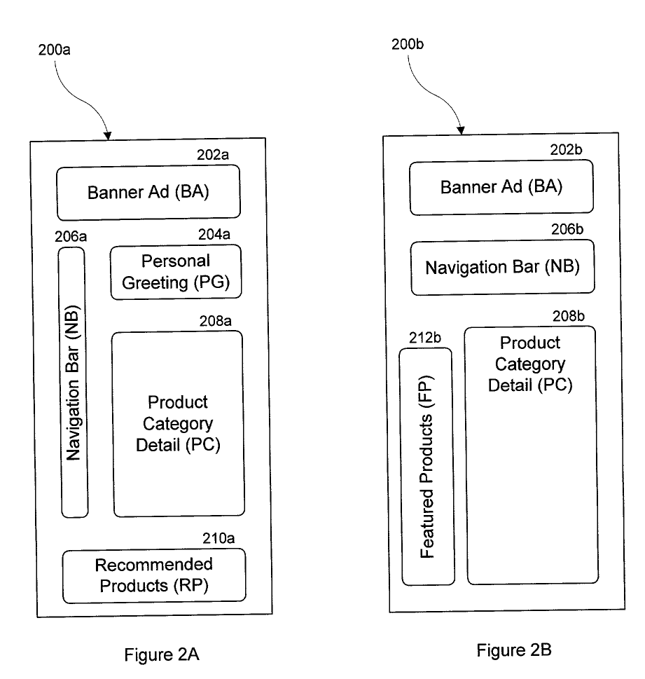

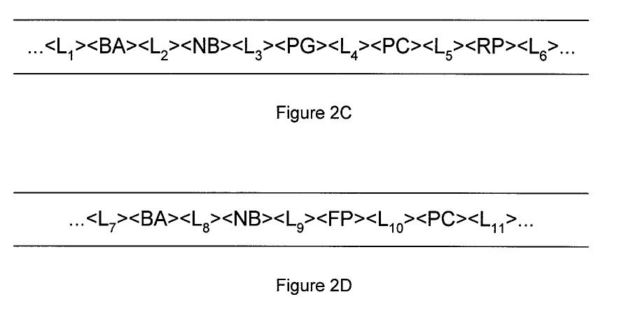

FIGS. 2A and 2B are simplified block diagrams of exemplary web pages having dynamic content. FIGS. 2A and 2B illustrate exemplary dynamic page layouts 200a and 200b for a web page, where the different layouts are determined by a particular user's set of parameters. Layouts 200a and 200b can be generated by the web site of an online book store catering to both registered users and non-registered users. Registered users are users that have set up an account (including a set of parameters) with the site. Non-registered users are infrequent and/or anonymous visitors.

A registered user enters the site by starting at the entry page of the site (in other words, the page presented to the user following login). The entry page presents a list of category links that the user can choose to navigate the site. If the user clicks on the “Fiction” category, a URL request including a category ID=Fiction parameter is sent to the site's web server. An application server at the site will execute the proper script to generate the next web page. The script takes the categoryID input parameter and retrieves the content associated with the fiction category. Such a request for a registered user could generate the exemplary web page 200a shown in FIG. 2A.

Page 200a includes a number of content elements or fragments. The banner ad (BA) fragment 202a includes an advertisement retrieved from an ad server based on the user's referring URL and the current time. The personal greeting (PG) fragment 204a includes a greeting for the user including the user's name (retrieved from the registered user's profile object accessed at login) and the current time. The navigation bar (NB) fragment 206a displays the navigation selections available such as the subcategories of the current category. The product category detail (PC) fragment 208a displays the names, descriptions, and images associated with the products in the fiction category. The product information can be obtained by querying a content database. Finally, the recommended products (RP) fragment 210a includes a list of recommended products that are retrieved from a personalization server based on the current category and user profile information.

Some of the fragments of page 200a are based on user profile information that is only available for registered users. For example, personal greeting fragment 204a, which includes the user's name, can only be generated from a registered user's profile.

A non-registered user enters the web site by starting at the web site's home page. When the non-registered user selects the fiction category link, exactly the same URL request as for the registered user, including the category ID=Fiction parameter, is sent to the site's server. However, for the non-registered user, the site can provide web page 200b, instead of page 200a. As shown in FIG. 2B, the content and the layout of page 200b are different than that of page 200a. For content, page 200b includes banner ad fragment 202b, corresponding to banner ad fragment 202a; navigation bar fragment 206b, corresponding to navigation bar fragment 206a; and product category detail fragment 208b, corresponding to product category detail fragment 208a. However, page 200b also includes a featured products fragment 212b, rather than the personal greeting and recommended products fragments 204a and 210a. For layout, navigation bar 206b appears in a different place on the non-registered user's page 200b. Additionally, product category detail fragment 208 is displayed in two-column format rather than single-column format.

Those skilled in the art will appreciate that the differences between layout 200a and layout 200b are only provided as an example to illustrate that web page content and layout can depend upon the particular user's set of parameters.

In general, an HTML page consists of two distinct components: content and layout. Content refers to the actual information displayed and layout refers to a set of markup tags that define the presentation. The presentation is typically the location of the content on the page. For example, with respect to FIG. 2A, the different fragments 202a-210a represent content, and the layout determines how fragments 202a-210a are presented on page 200a. Examples of layout include an HTML tag, for example, <TABLE> or <TITLE>.

FIGS. 2C and 2D are simplified schematics of the layout of the exemplary web pages depicted in FIGS. 2A and 2B, respectively. FIG. 2C depicts an exemplary schematic of the layout for the registered user's page 200a. In FIG. 2C, each “<Lᵢ>” represents the layout for a particular section of page 200a. For example, each <Lᵢ> can include a string of markup tags, such as <TABLE WIDTH=“100%”><TR><TD> . . . . The remaining elements represent the content. For example <BA> denotes banner ad fragment 202a. FIG. 2D depicts the layout for the non-registered user's page 200b.

As FIGS. 2A-2D indicate, the final presentation of the page is partially determined by the order in which the markup tags appear. Clearly, the layout is also determined by the actual markup tags themselves (not shown in the figures).

FIGS. 2A-2D, and the corresponding discussion, illustrate two characteristics of dynamically generated content. First, the content and the page layout of the site can be dynamic. In other words, the precise organization of a page is often determined at run-time. Second, the same request URL can produce different content and/or different layouts. The registered and non-registered users can submit the exact same URL to the site, yet each can receive a different page based on the particular user's parameter set.

Because dynamic pages can be dynamic across two dimensions, content and layout, a dynamic content caching system that can account for both dimensions is desirable. The present invention can provide a system and method to cache such dynamic web pages.

Exemplary Embodiments of the Present Invention

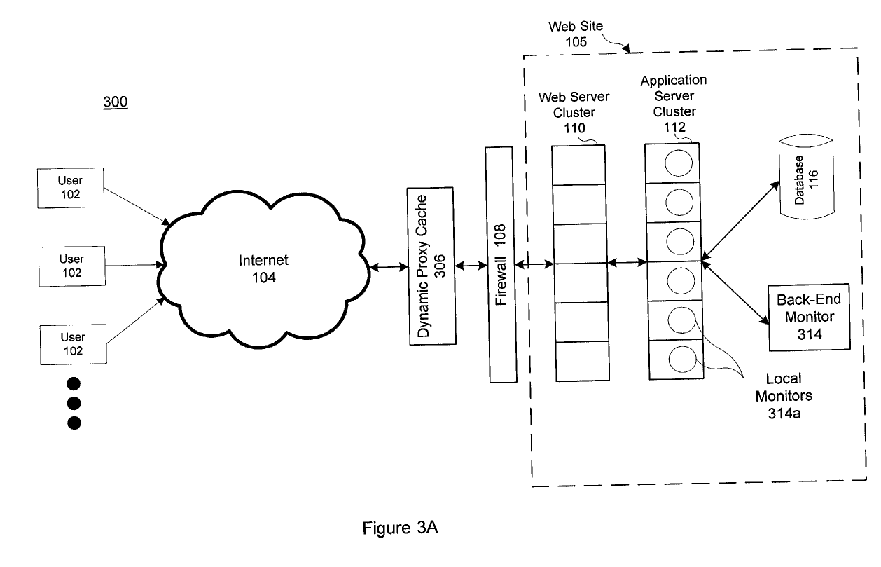

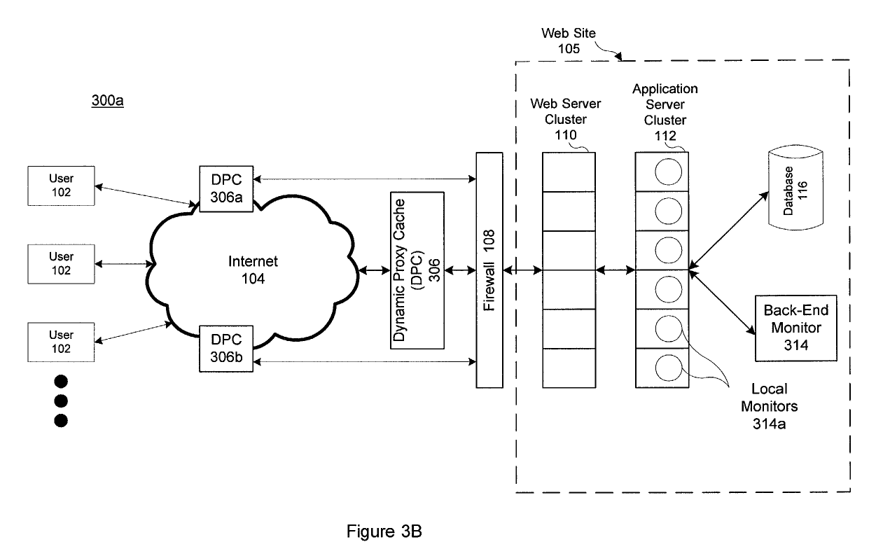

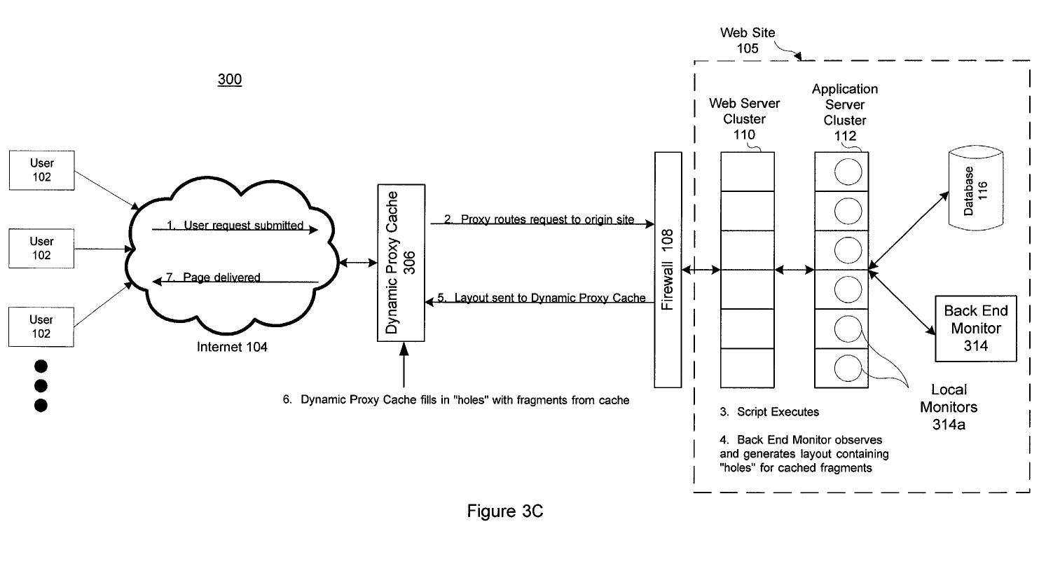

FIG. 3A is a block diagram depicting a network architecture 300 according to an exemplary embodiment of the present invention. As shown in FIG. 3A, the network architecture 300 can include components of a conventional web site architecture, as well as a dynamic proxy cache 306 (DPC) and a back end monitor 314.

Dynamic proxy cache 306 can reside outside firewall 108 and can store various types of objects. The objects can include rich content, static HTML files, HTML fragments (statically or dynamically generated), and page layouts. Dynamic proxy cache 306 can receive a web page request and can pass it to back end monitor 314 via web server 110 and application server 112. Back end monitor 314 can perform any necessary processing and can generate and send page layout instructions (along with some content) to dynamic proxy cache 306. Then, dynamic proxy cache 306 can assemble and can serve the request based on the layout instructions. Dynamic proxy cache 306 also can receive and execute cache management instructions from the back end.

Dynamic proxy cache 306 can be a proxy cache that can store dynamic content fragments and can assemble those fragments on demand using run-time page layout instructions. Dynamic proxy cache 306 can assemble pages by processing the instructions provided by back end monitor 314. Dynamic proxy cache 306 can include a structure implemented as an in-memory array of pointers to cached fragments. An array index can provide a direct link to the cached fragment.

Back end monitor 314 can observe the back end processing and can dynamically determine the page layout instructions. It can then forward those instructions to dynamic proxy cache 306. Back end monitor 314 also can control the cache management of dynamic proxy cache 306. For example, back end monitor 314 can notify dynamic proxy cache 306 when changes in content cause a fragment to become invalid, in other words, unusable. As shown in FIG. 3A, a single back end monitor 314 can communicate with a cluster of application servers 112. Back end monitor 314 also can cache intermediate output (for example, programmatic objects such as scripts). Back end monitor 314 also can have a lightweight client or local monitor component 314a (“lightweight” generally refers to a single-threaded process that runs on an operating system). Local monitors 314a can determine the page layout instructions for requests by monitoring the processing at each application server 112.

In general, dynamic content fragments can be cached in dynamic proxy cache 306, while layout information can be generated on demand from back end monitor 314 at the source site infrastructure. Accordingly, the network architecture 300 according to an exemplary embodiment of the present invention can provide significant reductions in bandwidth requirements, because only the page layouts, and perhaps some content, are transmitted from back end monitor 314 to dynamic proxy cache 306. Additionally, network architecture 300 can accommodate dynamic page layouts, because the back end monitor 314 can generate the layout information on demand.

FIG. 3B is a block diagram depicting a network architecture 300a showing alternative locations of dynamic proxy cache 306a, 306b according to exemplary embodiments of the present invention. As shown in FIG. 3B, the dynamic proxy cache can reside either (a) at the origin site (in a reverse proxy configuration represented by dynamic proxy cache 306), or (b) at the network edge (in a forward proxy configuration represented by one or both of dynamic proxy cache 306a and 306b). The forward proxy configuration can include dynamic proxy cache 306a or 306b. Alternatively, the forward proxy configuration can include both dynamic proxy caches 306a and 306b, as well as additional dynamic proxy caches (not shown). The primary benefit of the reverse proxy configuration is the reduction in the number of bytes transferred through the site infrastructure for each request. The forward proxy configuration can result in even greater benefits because the reduction in bytes transferred for each request can be realized within the site infrastructure as well as across the Internet. The main difference between the two is that a forward proxy configuration typically would mandate a distributed cache architecture, whereas a reverse proxy configuration can be implemented as a single unit.

FIG. 3C is a block diagram depicting a process of operation of web site architecture 300 according to an exemplary embodiment of the present invention. Dynamic proxy cache 306 can include cached content. Dynamic proxy cache 306 can receive a web page request (step 1) and can route the request to origin web site 105 (step 2). At web site 105, application server 112 can execute a script to serve the request (step 3). Back end monitor 314 can observe the application processing and can generate a template of the page layout (step 4). The template can include a condensed string representing the user deliverable page. The template can include page layout instructions and “holes” (placeholders) to indicate where cached fragments can be inserted. Application server 112 then sends the template to dynamic proxy cache 306 (step 5), which fills in the “holes” with the appropriate fragments from its cache (step 6). As described more fully below, each “hole” in the template can include a reference to content stored in the dynamic proxy cache. The dynamic proxy cache can then retrieve the referenced content to fill in each “hole.” The resulting page can then be delivered to user 102 (step 7).

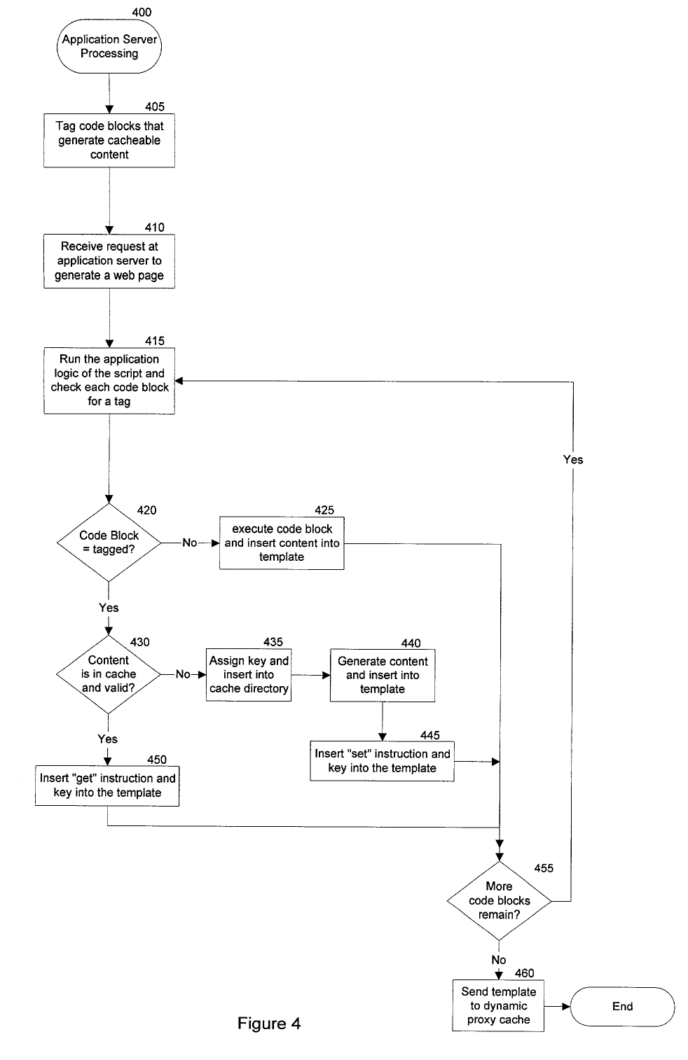

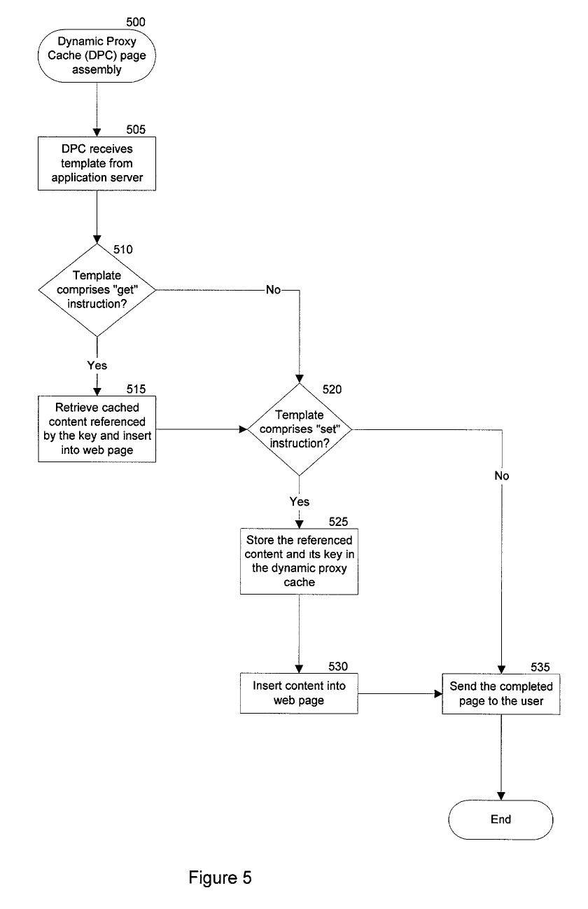

FIG. 4 is a flow chart depicting a method 400 for application server processing according to an exemplary embodiment of the present invention. Method 400 can include step 405 in which code blocks that generate cacheable content can be tagged. In step 410, a request to generate a web page can be received at the application server. Then in step 415, the application logic of the script can be executed and each code block can be checked for a tag. In step 420, it can be determined whether a particular code block is tagged, indicating that it includes cacheable content. If the particular code block is not tagged, then the method branches to step 425. In step 425, the logic of the code block can be executed and the resulting content can be inserted into the template. The method then proceeds to step 455, where it can be determined whether more code blocks remain to be executed. If more code blocks remain, then the method branches back to step 415. If step 455 determines that more code blocks do not remain, then the method branches to step 460, where the template can be sent to the dynamic proxy cache.

If step 420 determines that the code block is tagged, then the method branches to step 430. In step 430, it can be determined whether the cacheable content is contained in the dynamic proxy cache and is valid. Typically, a fragment can become invalid by (a) an invalidation policy that can determine that a fragment is not valid, or (b) a replacement policy that can determine that a fragment should be evicted from cache. For example, fragments can become invalid due to expiration of the time-to-live or updates to the underlying data sources. (The time-to-live specifies a set period of time for which a particular fragment is valid.) Alternatively, a cache replacement manager can monitor the size of the cache directory and can select fragments for replacement when the directory size exceeds a specified threshold. If a particular fragment becomes invalid, a flag can be set to FALSE to indicate that the particular fragment is not valid. Accordingly, a subsequent request for the particular fragment will result in the fragment being regenerated and served fresh.

If step 430 determines that the cacheable content is contained in the dynamic proxy cache and valid, then the method branches to step 450. In step 450, a “get” instruction can be inserted into the template. Also in step 450, a key representing the cacheable content can be inserted in the template. The method then proceeds to step 455, as described above.

If step 430 determines that the cacheable content is not contained in the dynamic proxy cache, or is contained in the dynamic proxy cache but not valid, then the method branches to step 435. In step 435, a key can be assigned to the cacheable content. The key also can be inserted into the cache directory of the back end monitor. Then in step 440, the content of the code block can be generated and can be inserted into the template. In step 445, a “set” instruction can be inserted into the template, as well as the key generated in step 440. The method then proceeds to step 455, as described above.

As discussed above, the template can be sent to the dynamic proxy cache in step 460. The dynamic proxy cache can then receive the template and assemble the web page. The processing performed by the dynamic proxy cache after receiving the template will be discussed below.

FIG. 5 is a flow chart depicting a method 500 for web page assembly according to an exemplary embodiment of the present invention. Method 500 can include step 505 in which the dynamic proxy cache receives a template from the application server. Then in step 510, method 500 can determine whether the template includes a “get” instruction, instructing the dynamic proxy cache to retrieve cached content from its memory. The “get” instruction can include a key referencing the cached content in the dynamic proxy cache. If method 500 determines in step 510 that the template does not include a “get” instruction, then the method branches to step 520, discussed below. If step 510 determines that the template includes a “get” instruction, then the method branches to step 515. In step 515, the dynamic proxy cache can retrieve the cached content and can insert the cached content into the web page, as instructed by the template. The method then proceeds to step 520, discussed below.

In step 520, method 500 can determine whether the template includes a “set” instruction. The “set” instruction can instruct the dynamic proxy cache to store specific content. The specific content can be identified by a key. If step 520 determines that the template includes a “set” instruction, then the method branches to step 525. In step 525, the dynamic proxy cache can store the cacheable content identified by the key in the “set” instruction. Then in step 530, the cacheable content can be inserted into the web page. If necessary, steps 510-530 can be repeated to account for all “get” and “set” commands in the template (not shown). The method then proceeds to step 535, where the completed web page can be sent to the user. If step 520 determines that the template does not include a “set” instruction, then the method branches directly to step 535.

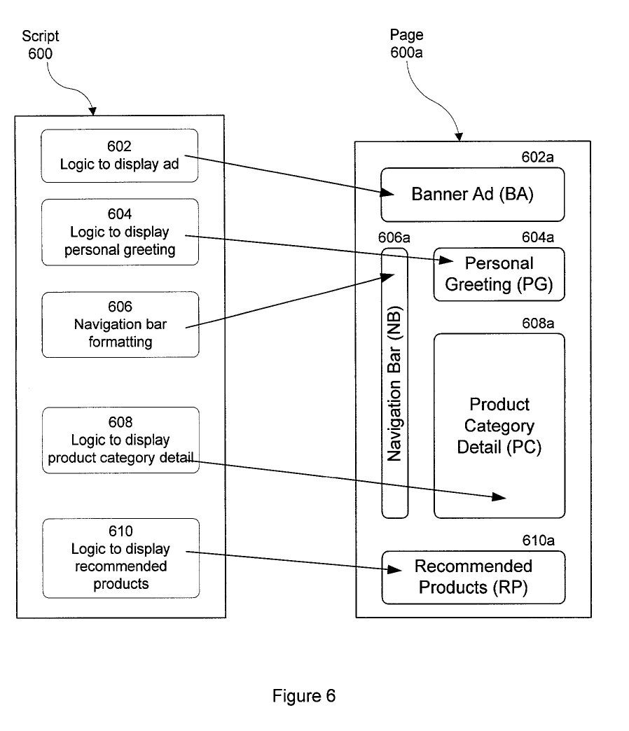

With reference to FIGS. 6-9, an example of the processing of method 400 will be described. FIG. 6 is a block diagram depicting an exemplary script 600 and a corresponding web page 600a that the script may generate. Web page 600a can include content fragments 602a-610a corresponding to content fragments 202a-210a described earlier with reference to FIG. 2A. As shown in FIG. 6, script 600 can include code blocks 602-610 to generate the respective content fragments 602a-610a of web page 600a. Each code block 602-610 can include the logic to generate the corresponding content fragment.

As described earlier, banner ad fragment 602a and personal greeting fragment 604a can be state-dependent, because they can depend on the current time. Accordingly, both fragments 602a and 604a can be considered non-cacheable and can be generated for each request. Fragments 606a-610a can be cacheable. Accordingly, each of code blocks 606, 608, and 610 can be tagged as corresponding to cacheable content. Code blocks 606-610 can be tagged by inserting application programming interfaces (APIs) around the code block, enabling the output of the code block to be cached at run-time. Each tag can provide a unique identifier to the corresponding cacheable fragment. Additionally, each tag can provide additional metadata. For example, metadata can include a time-to-live (ttl).

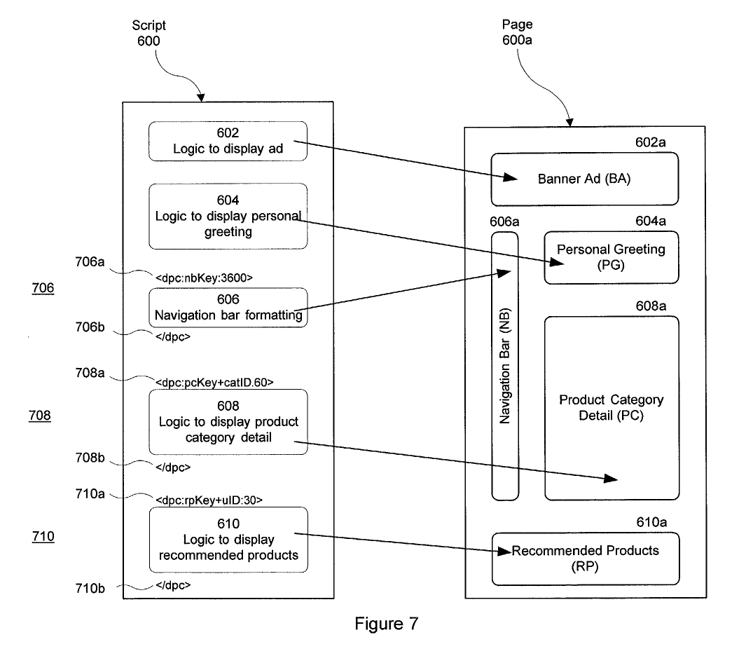

FIG. 7 is a block diagram depicting script 600 associated with code block tags 706, 708, and 710 according to an exemplary embodiment of the present invention. As shown in FIG. 7, code blocks 602 and 604 of script 600 can include non-cacheable content. Accordingly, code blocks 602 and 604 do not include a tag, indicating that the corresponding content will be generated each time script 600 is executed. Code blocks 606, 608, and 610 include tags 706, 708, and 710, respectively. Tags 706-710 indicate that the corresponding content is cacheable.

Each of tags 706-710 can have a similar format. Additionally, each code block can include a single tag, or each code block can have a plurality of tags. For example, each code block can have a “begin tag” at the beginning of the code block and an “end tag” at the end of the code block. In FIG. 7, items 706a, 708a, and 710a represent begin tags. Items 706b, 708b, and 710b represent end tags.

A begin tag can have the following basic format: <dpc:fragmentID:ttl>, where “dpc” can be a constant indicating the start of a tag, “fragmentID” can be a unique string to identify the content fragment, and “ttl” can be a time-to-live value. The fragmentID can include a name element alone, or a name element and a parameter list element. The name element can be a name assigned to the fragment. The parameter list element can be an optional list of run-time parameters. For example, as shown in FIG. 7, navigation bar code block 606 has been assigned begin tag 706a comprising “<dpc:nbKey:3600>.” Accordingly, begin tag 706a comprises only the fragment name “nbKey” and a time-to-live of one day (3600 minutes). Product category detail fragment has been assigned a begin tag 708a comprising “<dpc:pcKey+catID:60>.” Accordingly, begin tag 708a includes the fragment name “pcKey,” the catID parameter (the parameter list), and a time-to-live of one hour (60 minutes).

An end tag can be constant and can have the format: </dpc>. Tags according to the present invention are not limited to those discussed above. The tags can have a different format than described above and/or can include more or less information. For example, the tags can include keywords to support keyword-based invalidation. Additionally, the tags can include only a key indicating the content in the cache directory.

In operation, a request to generate a web page can be received by the application server. The request can cause script 600 to be invoked and can cause execution of script 600 to begin. The application logic of script 600 can be executed until a tagged code block is encountered. When a tagged code block is encountered, it can be determined whether the fragment produced by that code block exists in the dynamic proxy cache. That determination can be performed by searching for the fragment ID in the back end monitor's cache directory. The cache directory can include the fragment IDs and additional metadata for each fragment stored in the dynamic proxy cache. The cache directory can use a key to reference the content stored in the dynamic proxy cache.

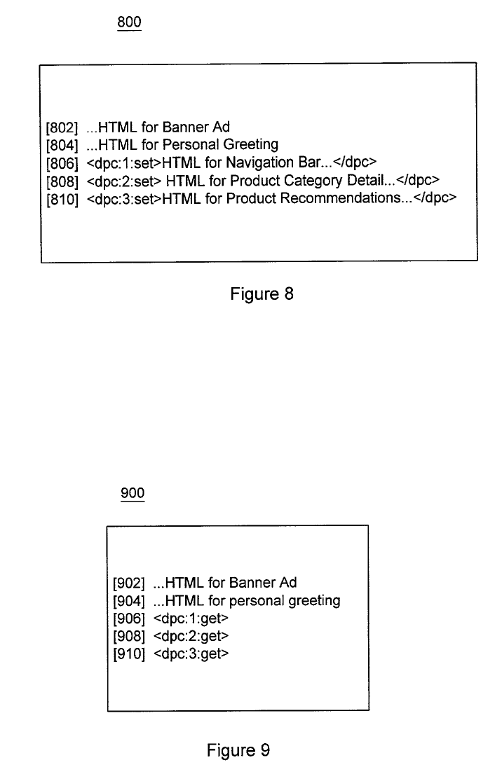

Web page templates generated by the back end monitor will now be discussed with reference to FIGS. 8 and 9. The first time script 600 is executed, the dynamic proxy cache will not include any of the content elements. Accordingly, cacheable content can be generated by the application server and forwarded to the dynamic proxy cache for storing in its memory. FIG. 8 illustrates a template 800 according to an exemplary embodiment of the present invention that can be generated by the application server for the initial execution of script 600. As shown, template 800 includes markers 802 and 804, which can include the content for the banner ad and personal greeting fragments corresponding to code blocks 602 and 604 of script 600. Because the content for those two fragments is not cacheable, that content can be generated each time script 600 is executed and can be inserted in the corresponding template. For code blocks 606-610 of script 600, it can be determined whether the cacheable content corresponding to those code blocks is contained in the dynamic proxy cache. Because this is the initial execution of script 600, the cacheable content is not contained in the dynamic proxy cache. Accordingly, the content can be generated by the application server and inserted into template 800 with the corresponding marker 806-810. Additionally, a “set” instruction can be inserted into template 800 to instruct the dynamic proxy cache to store the cacheable content in its memory.

For example, marker 806 comprises “<dpc:1:set>HTML for Navigation Bar . . . </dpc>.” In this exemplary embodiment, the integer “1” comprises the key referencing the cacheable content corresponding to code block 606 of script 600. Marker 806 further includes the content of code block 606, represented by “HTML for Navigation Bar,” and the “set” instruction. The “set” instruction can instruct the dynamic proxy cache to store the content and the key for the navigation bar.

When the dynamic proxy cache receives template 800 from the application server, it processes the instructions to assemble the web page for delivery to the user. Accordingly, the dynamic proxy cache inserts into the web page the content items associated with markers 802-810, as instructed in the template. Additionally, the dynamic proxy cache can store in its memory the key and the corresponding content for each of code blocks 806-810, as instructed by the “set” command.

FIG. 9 illustrates a template 900 according to an exemplary embodiment of the present invention that can be generated for subsequent executions of script 600. As shown, template 900 includes markers 902 and 904 which can include the content for the banner ad and personal greeting fragments corresponding to code blocks 602 and 604 of script 600. As stated above, the content for those fragments is not cacheable and can be generated each time script 600 is executed. For code blocks 606-610, the corresponding content is stored in dynamic proxy cache (unless the content has become invalid). Accordingly, the content corresponding to those code blocks does not need to be generated by the application server. A “get” instruction can be inserted in markers 906-910 of template 900 to instruct the dynamic proxy cache to retrieve the corresponding content fragment from its memory. Each marker 906-910 also can include the key referencing the particular content fragment in the cache directory.

When the dynamic proxy cache receives template 900, it can assemble the web page as instructed by markers 902-910. Accordingly, the dynamic proxy cache inserts the content associated with markers 902 and 904 into the web page. Additionally, the dynamic proxy cache retrieves the content associated with markers 906-910 from its memory and inserts that content into the web page. The dynamic proxy cache can be instructed to retrieve that content by the get command in each of markers 906-910. Additionally, the dynamic proxy cache can reference the specific keys to retrieve the specific content referenced by each marker 906-910.

As shown in FIGS. 8 and 9, the template size of the first and subsequent request can be significantly smaller, even for this simple example.

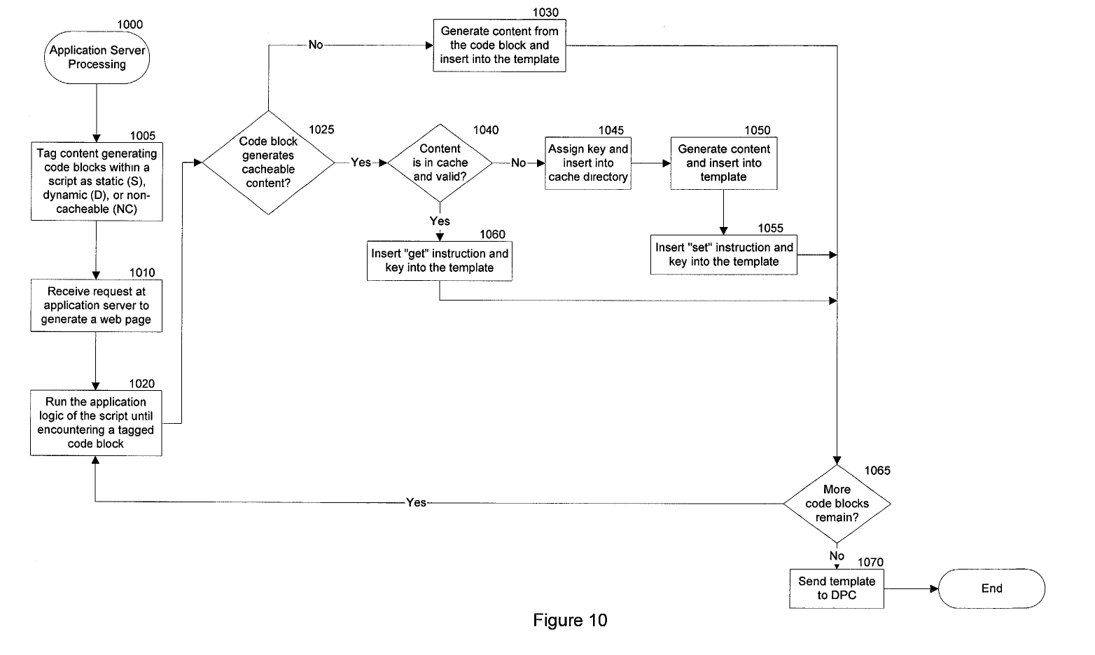

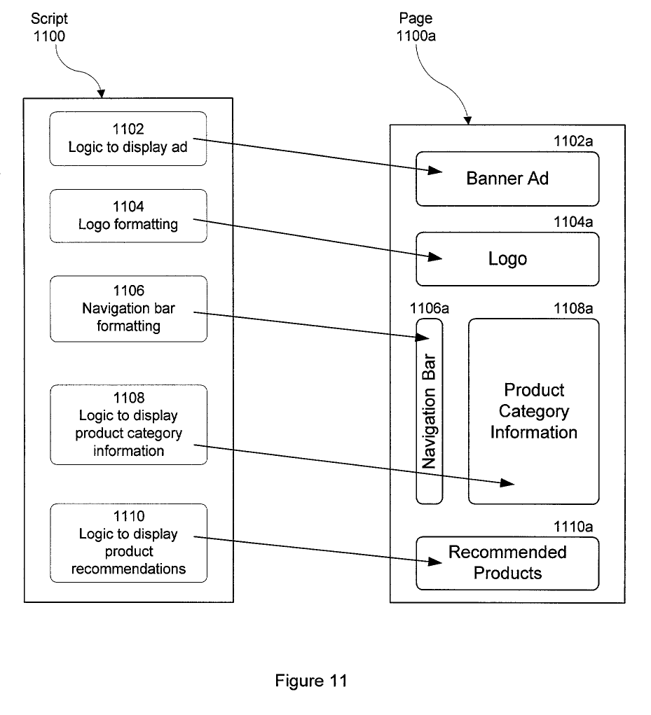

FIG. 10 is flow chart depicting a method 1000 for application server processing according to another exemplary embodiment of the present invention. Method 1000 includes step 1005 in which content-generating code blocks within a script can be tagged to indicate whether the code blocks are configured to generate cacheable content. For example, a content generating code block can be tagged with a “C” to indicate that its output is cacheable. Alternatively, a content generating code block can be tagged to further indicate that its cacheable output is dynamic or static. For example, a “D” tag can indicate a dynamic code block, and an “S” tag can indicate a static code block. Additionally, a content-generating code block can be tagged as producing non-cacheable content. For example, an “NC” tag can indicate a non-cacheable code block. Both static and dynamic code blocks produce cacheable output. Non-cacheable code blocks include logic that will be executed each time the script is invoked. Tagging the content-generating scripts can allow the page layouts to be captured at run-time.

In step 1010, a request to generate a web page can be received at the application server. Then, the application logic of the script can be executed in step 1020 until a tagged code block is encountered. In step 1025, it can be determined whether the tagged code block generates cacheable content. In this exemplary embodiment, the tagged code block can represent non-cacheable content if the tag includes an “NC” and cacheable content if the tag includes a “C.” Alternatively, the tagged code block can represent static, cacheable content if the tag includes an “S,” and dynamic, cacheable content if the tag includes a “D.” If the tagged code block represents non-cacheable content, then the method branches to step 1030. In step 1030, the content can be generated from the code block and inserted into the template. Method 1000 then proceeds to step 1065, where it can be determined whether more code blocks remain to be executed. If more code blocks remain to be executed, then the method branches back to step 1020 to continue executing the application logic of the script until another tagged code block is encountered. If it is determined in step 1065 that no more code blocks remain to be executed, then method 1000 branches to step 1070. In step 1070, the template can be sent to the dynamic proxy cache.

If method 1000 determines in step 1025 that the tagged code block represents cacheable content, then the method branches to step 1040, where it can be determined if the cacheable content is stored in the dynamic proxy cache and is valid. If the cacheable content is stored in the dynamic proxy cache and is valid, then the method branches to step 1060. In step 1060, the back end monitor can insert a “get” instruction into the template. The “get” instruction can instruct the dynamic proxy cache to retrieve the cacheable content from its memory. Also in step 1060, the back end monitor can insert into the template a key referencing the cacheable content stored in the dynamic proxy cache. The key can be obtained from a cache directory that maintains a record of content stored in the dynamic proxy cache. The method then proceeds to step 1065, as described above.

If method 1000 determines in step 1040 that the cacheable content is not in the dynamic proxy cache, or is in the dynamic proxy cache but not valid, then the method branches to step 1045. In step 1045, a key referencing the cacheable content can be assigned and inserted into the cache directory of the back end monitor. Then in step 1050, the cacheable content can be generated by executing the logic of the code block, and the cacheable content can be inserted into the template. In step 1055, the back end monitor can insert a “set” instruction into the template. The “set” instruction can instruct the dynamic proxy cache to store the cacheable content in its memory. Also in step 1055, the key assigned in step 1045 can be inserted into the template. The method then proceeds to step 1065, as described above.

As discussed earlier, method 1000 can determine in step 1065 whether more code blocks remain to be executed. If all of the code blocks in the script have been executed, then the method branches to step 1070. In step 1070, the application server can send the template to the dynamic proxy cache. The processing performed by the dynamic proxy cache after receiving the template is discussed above with reference to FIG. 5.

With reference to FIGS. 11-14, an example of the operation of methods 1000 and 500 will be described. FIG. 11 is a block diagram depicting an exemplary script 1100 and the corresponding web page 1100a that it can generate. Script 1100 can include code block 1102, which can include logic to generate an ad. Code block 1102 can generate a banner ad fragment 1102a of web page 1100a. If fragment 1102a includes an ad based on various state information such as the referring URL or the time of day, then the content generated by code block 1102 is non-cacheable. Accordingly, code block 1102 can be executed each time that script 1100 is executed.

Script 1100 also can include code block 1104, which can include logic to generate logo formatting. Code block 1102 can generate the content for logo fragment 1104a of web page 1100a. Generally, code block 1104 will have a standard formatting tag to display a standard logo. Accordingly, the content generated by code block 1104 is static and cacheable.

Script 1100 also can include code block 1106, which can include logic to generate navigation bar formatting. Code block 1106 can then generate the content for navigation bar fragment 1106a of web page 1100a. Code block 1106 can include a standard formatting tag to display the standard navigation bar. Accordingly, the content generated by code block 1106 is static and cacheable.

Script 1100 also can include code block 1108, which can include logic to generate product category information. Code block 1108 can generate the content for product category information fragment 1108a of web page 1100a. Code block 1108 can include logic that connects to a database and retrieves records for the product categories within the current category. The relevant attributes can be extracted and formatted as HTML. For example, the relevant attributes can include a name and a short description. Accordingly, the product category information can be common across all requests, making the content generated by code block 1108 cacheable, even though it is dynamic.

Script 1100 also can include code block 1110, which can include logic to generate product recommendations. Code block 1110 can generate recommended products fragment 1110a of web page 1100a. Code block 1110 can include logic that accesses a personalization engine to determine the appropriate product recommendations for a given user. Because product recommendations can be common across a group of customers, the content generated by code block 1110 is cacheable, even though it is dynamic.

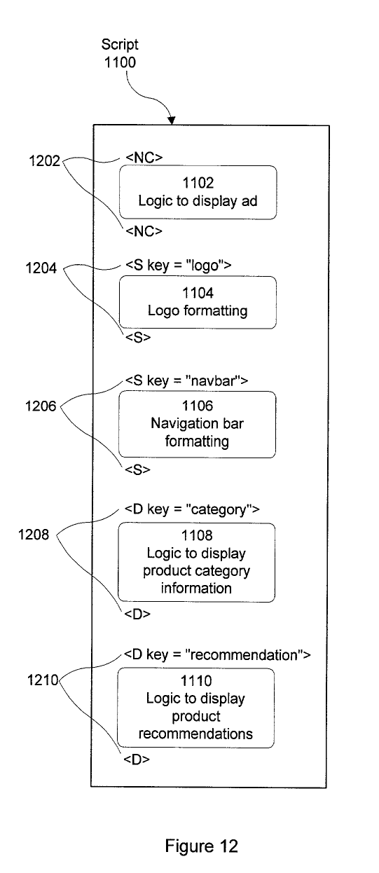

FIG. 12 is a block diagram depicting script 1100 having tags for each of its code blocks 1102-1110 according to an exemplary embodiment of the present invention. As shown, code blocks 1102-1110 can have corresponding tags 1202-1210. Tag 1202 can indicate that the content of code block 1102 is non-cacheable. Tags 1204 and 1206 can indicate that the content of code blocks 1104 and 1106 is static and cacheable. Tags 1208 and 1210 can indicate that the content of code blocks 1108 and 1110 is dynamic and cacheable. In this exemplary embodiment, tags 1202-1210 include the following: “NC” to indicate that the corresponding content is non-cacheable; “S” to indicate that the corresponding content is static and cacheable; or “D” to indicate that the corresponding content is dynamic and cacheable.

Additionally, tags for cacheable content also can include a key to identify the corresponding content in the cache directory. For example, tag 1204 includes a key “logo” to identify the content of code block 1104 in the cache directory. As shown in FIG. 12, the keys can include fixed strings. The keys also can include run-time parameters such as a category ID. Additionally, the keys can include metadata such as a time-to-live (ttl) for the fragment.

The first time that script 1100 (FIG. 12) is executed, the corresponding cache will be empty. Accordingly, the logic of code blocks 1102-1110 will be executed. Any cacheable content can then be inserted into the dynamic proxy cache.

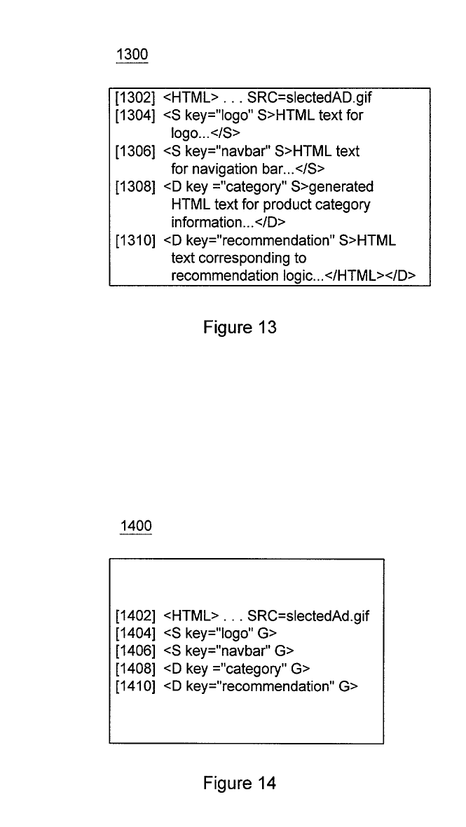

Web page templates generated by the back end monitor will now be discussed with reference to FIGS. 13 and 14. FIG. 13 illustrates a template 1300 according to an exemplary embodiment of the present invention that can be generated by an application server for the initial execution of script 1100. As shown in FIG. 13, template 1300 can include markers 1302-1310 corresponding to content generated by code blocks 1102-1110, respectively. Marker 1302 can include the content generated by the application server for code block 1102. Each of markers 1304 and 1306 can include the static content generated by the application server for code blocks 1104 and 1106, respectively, as well as a key referencing the static content in the cache directory. Additionally, markers 1304 and 1306 can include a “set” instruction, as indicated by an “S.” The “set” instruction can instruct the dynamic proxy cache to insert into its memory the respective keys and their corresponding static content.

Each of markers 1308 and 1310 can include the dynamic content generated by the application server for code blocks 1308 and 1310, respectively, as well as a key referencing the dynamic content in the cache directory. Markers 1308 and 1310 also can include a “set” instruction to instruct the dynamic proxy cache to insert into its memory the respective keys and their corresponding dynamic content.

When the dynamic proxy cache receives template 1300 from the application server, it follows the instructions to assemble the web page that can be sent to the user. Accordingly, the dynamic proxy cache inserts into the web page the content items associated with markers 1302-1310, as instructed in the template. Additionally, the dynamic proxy cache can store the key and the corresponding cacheable content associated with each of markers 1304-1310.

FIG. 14 illustrates a template according to an exemplary embodiment of the present invention that can be generated by an application server for subsequent execution of script 1100. When script 1100 is executed for a second time, the cached static and dynamic content can be available in the dynamic proxy cache. Accordingly, the back end monitor can generate the template illustrated in FIG. 14. In FIG. 14, markers 1402-1410 can represent the corresponding content generated by code blocks 1102-1110. Marker 1402 can include the non-cacheable content generated by the application server for code block 1102. Markers 1404 and 1406 can include only a key referencing the static content stored in the dynamic proxy cache.

Additionally, since the dynamic content is still valid, markers 1408 and 1410 can include only a key referencing the dynamic content in the dynamic proxy cache. As shown in FIG. 14, markers 1404-1410 can include a “get” instruction represented by the “G.” The “get” instruction can instruct the dynamic proxy cache to retrieve the content from its memory. As illustrated in FIGS. 13 and 14, the size of the template forwarded from the application server to the dynamic proxy cache is significantly smaller, even for this simple example.

When the dynamic proxy cache receives template 1400, it assembles the web page as instructed by markers 1402-1410. Accordingly, the dynamic proxy cache inserts into the web page the content associated with marker 1402. Additionally, the dynamic proxy cache retrieves from its memory the content associated with markers 1404-1410 and inserts it into the web page. The dynamic proxy cache can be instructed to retrieve that content by the get command in each of markers 1404-1410. Additionally, the dynamic proxy cache can reference the specific keys to retrieve the specific content referenced by each marker 1404-1410.

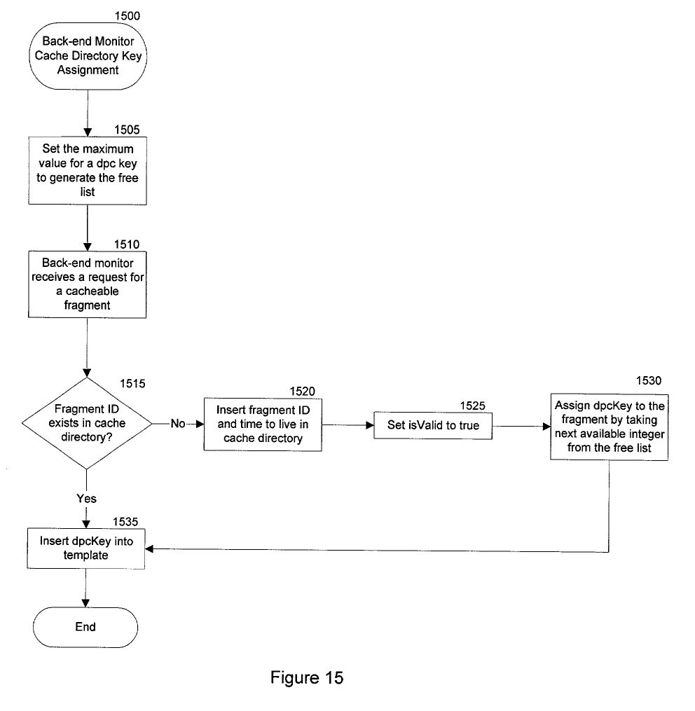

The back end monitor can include a cache directory to facilitate management of the dynamic proxy cache. The cache directory can monitor content fragments and their respective metadata in the dynamic proxy cache. The cache directory can include the keys of all content fragments stored in the dynamic proxy cache. The cache directory can have the following structure for each cacheable fragment: (1) A fragment ID, which can have a unique fragment identifier. For example, the fragment ID can be a name. Alternatively, the fragment ID can be a name and a parameter list. (2) A dynamic proxy cache key (dpcKey), which can include a unique fragment identifier assigned by a key assigning method (see FIG. 15, discussed below). (3) An “isValid” flag, which can indicate if the fragment is valid or invalid. And (4) a time-to-live (ttl) value for the fragment.

The dpcKey can be a unique integer identifier associated with each content fragment. The dpcKey can be a common key for both the back end monitor and the dynamic proxy cache. Using an integer as the dpcKey can reduce the tag size. The fragment IDs can be quite long, especially those that include a list of parameters. By assigning an integer as the dpcKey, the page template size being sent to the dynamic proxy cache can be reduced. Additionally, assigning a common key for both the back end monitor and the dynamic proxy cache can eliminate the need for explicit communication between those components.

Key assignment will now be described with reference to FIG. 15. FIG. 15 is a flow chart depicting a method 1500 for cache directory key assignment according to an exemplary embodiment of the present invention. The key can be assigned at run-time using key assignment method 1500. The key can be an integer value drawn from a pool of integers allocated at system initialization. For example, the pool of integers can be 1, 2, . . . N. In step 1505 of method 1500, the maximum key value, N, can be set to establish the “free list.” The maximum key value, N, can be chosen such that it provides an upper bound on the number of cacheable fragments. Typically, N can be computed by dividing available memory by the average size of a fragment. The resulting integer pool can be maintained as a queue called the “free list.”

In step 1510, the back end monitor can receive a run-time request for a cacheable content fragment. When the run-time request is received, it can be determined in step 1515 whether the content fragment ID exists in the cache directory. If the fragment ID does not exist, then the method branches to step 1520, where the fragment ID can be inserted into the cache directory. Also in step 1520, the fragment's time-to-live value can be inserted into the cache directory. In step 1525, the fragment's isValid flag can be set to “true” to indicate that the fragment is valid. Then, a key can be assigned to the fragment in step 1530 by assigning the next available integer from the free list. The method then proceeds to step 1535, where the key can be inserted into the page template. Additionally, the key can be used as the key in the dynamic proxy cache. If step 1515 determines that the fragment ID exists in the cache directory, then the method branches directly to step 1535.

Key assignment method 1500 described above is best suited for a system including a single dynamic proxy cache. In other words, key assignment method 1500 is best suited for a system having a reverse proxy configuration. However, key assignment method 1500 can be modified to accommodate multiple dynamic proxy caches. Multiple dynamic proxy caches can be encountered in a forward proxy configuration.

In a system having multiple dynamic proxy caches, a back end monitor using method 1500 could incorrectly determine that content is stored in a particular dynamic proxy cache. For example, two dynamic proxy caches, A and B, can exist. DPC A can receive a request for content C1. Since it is the first request, the back end monitor can assign a key to content C1, can generate the content C1, and then can send the content C1 and the key to DPC A. DPC A can then insert the content C1 and the key into its memory. Subsequently, DPC B can receive a request for content C1. At this point, the back end monitor thinks that content C1 exists in the dynamic proxy cache. However, the back end monitor cannot determine that content C1 only exists in DPC A.

One method to allow the back end monitor to determine which dynamic proxy cache includes specific content is to simply maintain key information for each cache. However, that method will require storing a number of keys, “n,” for each of the dynamic proxy caches, “m.” As used for providing content over the Internet, n can be on the order of millions, and m can be on the order of hundreds to thousands, thus creating the problem of storing an enormous amount of information, which will greatly increase the cache lookup time.

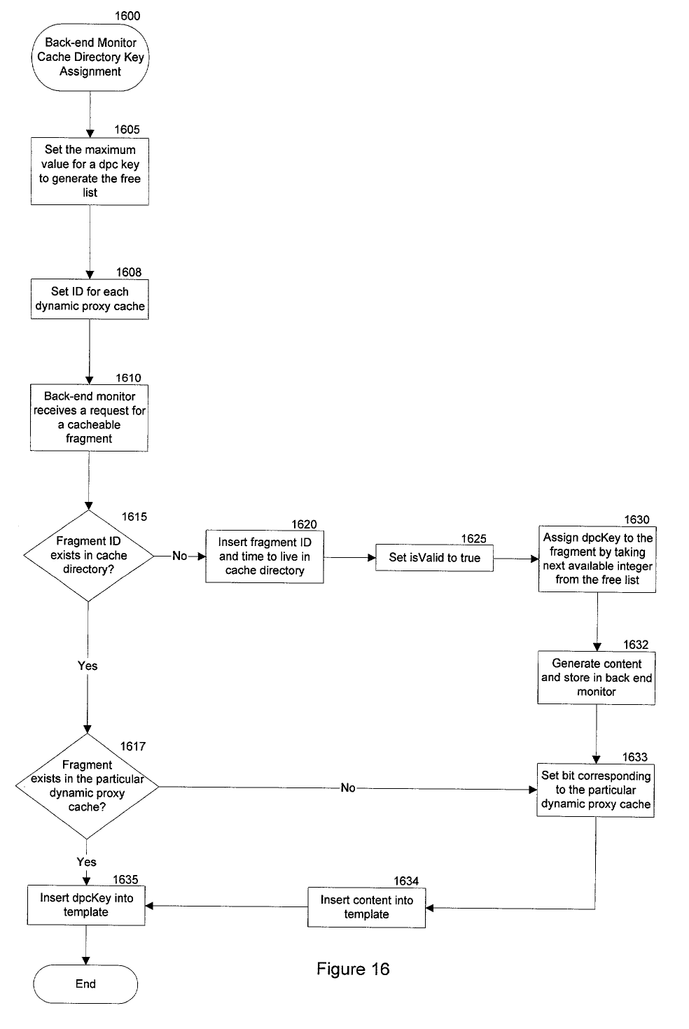

Another method for allowing the back end monitor to determine which dynamic proxy cache contains specific content is shown in FIG. 16. FIG. 16 is a flow chart depicting a method 1600 for cache directory key assignment according to an exemplary embodiment of the present invention in a system having more than one dynamic proxy cache. The key can be assigned at run-time. For each key, a bit vector can be maintained in the cache directory representing the set of all dynamic proxy caches. In other words, a bit vector for a given key “k” can have cardinality equal to m, the number of dynamic proxy caches. Cardinality refers to the number of bits in the bit vector, where the number of bits can correspond to the number of dynamic proxy caches m associated with a given key k. If the i^{th} bit for key k is set, then the i^{th} dynamic proxy cache includes a valid copy of the content associated with key k.

As shown in FIG. 16, method 1600 operates as follows. In step 1605, the maximum key value, N, can be set as described above for method 1500 to establish the “free list.” In step 1608, an identifier can be established for each dynamic proxy cache. The identifier can act as an index into the bit vectors described above, which can be maintained for each key. The identifier can be an integer assigned to a particular dynamic proxy cache. This integer can be mapped to some other identifier of the dynamic proxy cache, such as an Internet Protocol (IP) address. In step 1610, the back end monitor can receive a run-time request for a cacheable content fragment. The request can include the identifier from the particular dynamic proxy cache. In step 1615, the back end monitor can determine whether the content fragment's ID exists in the cache directory. If the fragment ID does not exist, then the method branches to step 1620, where the fragment ID can be inserted into the cache directory. Also in step 1620, the fragment's time-to-live value can be inserted into the cache directory. In step 1625, the fragment's isValid flag can be set to “true” to indicate that the fragment is valid. Then, a key can be assigned to the fragment in step 1630 by assigning the next available integer from the free list. In step 1632, the content can be generated and stored in the back end monitor. In step 1633, the bit corresponding to the particular dynamic proxy cache can be set in the bit vector of the key. The method then proceeds to step 1634, where the content can be inserted into the page template. Then, in step 1635, the key can be inserted into the page template. Additionally, the key can be used as the key in the dynamic proxy cache.

If step 1615 determines that the cache directory includes a key referencing the content fragment, then the method branches to step 1617. In step 1617, the back end monitor can determine whether the bit corresponding to the particular dynamic proxy cache is set in the key. If the appropriate bit in the key is set, then the content fragment exists in the particular dynamic proxy cache, and the method branches to step 1635, described above. If the appropriate bit is not set, then the content fragment does not exist in the particular dynamic proxy cache, and the method branches to step 1633, described above.

As needed, a “get” command, or a “set” command and the content, also can be inserted into the template as described above with reference to FIGS. 4 and 10. In other words, if the particular dynamic proxy cache includes the content fragment, then a “get” command can be inserted into the template. If the particular dynamic proxy cache does not include the content fragment, then a “set” command and the content can be inserted into the template.

In an exemplary embodiment where the system architecture includes more than one dynamic proxy cache, the back end monitor can store the content associated with each key. Thus, the back end monitor can store not only a key and its associated metadata, but also its corresponding content. Accordingly, unnecessary regeneration of cacheable content can be avoided. For instance, consider the example described above for a system having dynamic proxy caches A and B. DPC A can receive a request for content C1. Since it is the first request, the back end monitor can assign a key to content C1, can generate content C1, and then can send content C1 and the key to DPC A. The back end monitor can also store content C1. DPC A can then insert the content C1 and the key into its memory. Subsequently, DPC B can receive a request for content C1. At this point, method 1600 can determine that the fragment ID for content C1 exists in the cache directory and that content C1 does not exist in DPC B. If the back end monitor did not store content C1, then content C1 would have to be regenerated (or transferred from DPC A) to send it to DPC B. However, because the backend monitor can store content C1, it can then insert content C1 into the template to send it to DPC B.

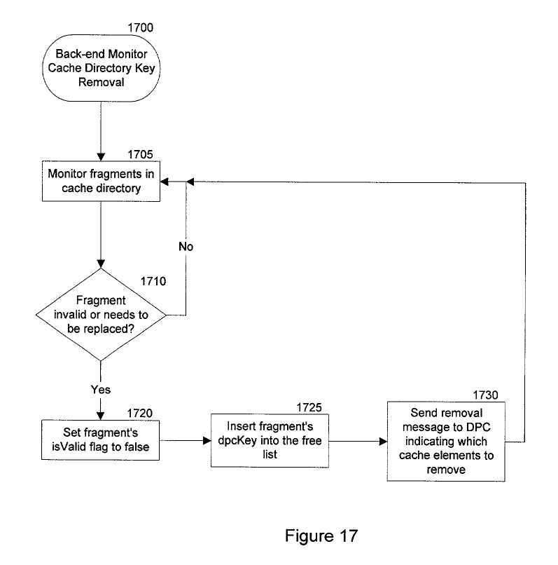

Key removal will now be described with reference to FIG. 17. FIG. 17 is a flow chart depicting a method 1700 for cache directory key removal according to an exemplary embodiment of the present invention. When a content fragment becomes invalid, the cache directory can be updated to indicate the current status of the fragment and to free the fragment's key for future use. In step 1705 of method 1700, a cache invalidation manager can monitor fragments to determine when they become invalid. Typically, a fragment can become invalid by (a) an invalidation policy that can determine that a fragment is invalid, or (b) a replacement policy that can determine that a fragment should be evicted from cache. For example, fragments can become invalid due to expiration of the time-to-live or updates to the underlying data sources. Alternatively, the cache replacement manager can monitor the size of the cache directory and can select fragments for replacement when the directory size exceeds a specified threshold.

In step 1710, it can be determined whether a particular fragment is invalid or needs to be replaced. If the particular fragment is not invalid or does not need replacement, then the method branches back to step 1705 to monitor another fragment. If step 1710 determines that the particular fragment is invalid or needs replacement, then the method branches to step 1720. In step 1720, the fragment's isValid flag can be set to FALSE to indicate that it is not valid. Accordingly, a subsequent request for the particular fragment will result in the fragment being regenerated and served fresh. In a forward proxy configuration, all bits for the fragment's key also can be cleared when the particular fragment becomes invalid. Accordingly, a subsequent request for the particular fragment, regardless of which dynamic proxy cache originates the request, will result in the fragment being regenerated and served fresh. The method then proceeds to step 1725, where the fragment's key can be inserted at the end of the free List.

In step 1730, the back end monitor can update the dynamic proxy cache by sending a removal message to the dynamic proxy cache. The removal message can instruct the dynamic proxy cache to remove the invalid content fragment from its memory. The back end monitor can send the removal message each time a fragment is determined to be invalid. Alternatively, the back end monitor can send the removal message at periodic intervals, after a specified number of fragments become invalid, or after a specified memory size of fragments becomes invalid. Key removal method 1700 can be independent of key assignment methods 1500 and 1600.

Alternatively, invalid fragments do not have to be explicitly removed from the dynamic proxy cache. The slots corresponding to the invalid fragments can simply remain unused until they are subsequently assigned to a new fragment by the back end monitor. For example, suppose a navigation bar fragment having dpcKey 2 becomes invalid. That fragment can be marked as invalid by the back end monitor, and “2” can be inserted back into the free List. The dynamic proxy cache does not have to take any action. Eventually, dpcKey 2 can be assigned to another fragment (either the navigation bar fragment or a new fragment) by the back end monitor, at which time the appropriate content will be inserted into the corresponding slot in the dynamic proxy cache.

In addition to managing the dynamic proxy cache, the back end monitor also can cache other types of objects. In some cases, it can be beneficial to cache intermediate objects rather than user-deliverable fragments. For instance, in the example described earlier with reference to FIGS. 6-9, a user profile object can be used to generate both the personal greeting and the recommended products fragments. The web site can cache the intermediate user profile object so that it can be used across multiple requests by that user. The back end monitor can support caching of such objects. Additionally, the back end monitor can cache any arbitrary object that can be serializable. Objects that are cacheable can be tagged in a manner similar to the tagging methods described above. However, those objects can be given a special identifier to indicate that they are to be cached in the back end monitor and that they are not to be sent to the dynamic proxy cache.

The present invention can be used with computer hardware and software that performs the methods and processing functions described above. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the present invention have been described above in detail, the description is merely for purposes of illustration. Various modifications of, and equivalent steps corresponding to, the disclosed aspects of the exemplary embodiments, in addition to those described above, may be made by those skilled in the art without departing from the spirit and scope of the present invention defined in the following claims, the scope of which is to be accorded the broadest interpretation so as to encompass such modifications and equivalent structures.

What is claimed is:

1. A web page delivery system for dynamically generating a web page comprising cacheable content, said delivery system comprising:
an origin site infrastructure comprising
an application server operative to receive a web page request from a user, to generate a web page template corresponding to a layout of the web page, and to forward the template for creation of the web page, and
a back end monitor operative to insert a key into the template, the key identifying a cacheable content fragment; and
a dynamic proxy cache operative to receive the template from said application server, to create the web page as instructed in the template by inserting the cacheable content fragment identified by the key, and to deliver the web page to the user.

2. A web page delivery system according to claim 1, wherein said back end monitor is further operative to determine whether the web page comprises the cacheable content fragment, and
wherein said back end monitor inserts the key into the template in response to a determination that the web page comprises the cacheable content fragment.

3. A web page delivery system according to claim 1, wherein said back end monitor is further operative to determine whether the cacheable content fragment is stored in said dynamic proxy cache, and
wherein said back end monitor inserts the key into the template in response to a determination that the cacheable content fragment is stored in said dynamic proxy cache.

4. A web page delivery system according to claim 1, wherein said back end monitor is further operative to determine whether the cacheable content fragment is stored in said dynamic proxy cache,
wherein said back end monitor generates the cacheable content fragment and inserts the cacheable content fragment into the template in response to a determination that the cacheable content fragment is not stored in said dynamic proxy cache, and
wherein said dynamic proxy cache stores the cacheable content fragment after receiving the template from said application server.

5. A web page delivery system according to claim 1, wherein said back end monitor is further operative to maintain a cache directory comprising information that the cacheable content fragment is stored in said dynamic proxy cache.

6. A web page delivery system according to claim 5, wherein said back end monitor is further operative to update the cache directory if the cacheable content fragment becomes invalid.

7. A web page delivery system according to claim 6, wherein said back end monitor is further operative to send a message to said dynamic proxy cache to remove the invalid cacheable content fragment.

8. A web page delivery system according to claim 1, further comprising a plurality of dynamic proxy caches,
wherein said back end monitor is further operative determine whether the cacheable content fragment is stored in a specific one of said plurality of dynamic proxy caches.

9. A web page delivery system according to claim 8, wherein said back end monitor is further operative to maintain a cache directory comprising information indicating whether the cacheable content fragment is stored in a specific one of said plurality of dynamic proxy caches.

10. A web page delivery system according to claim 9, wherein the information comprises a bit vector associated with the cacheable content fragment.

11. A method for delivering a web page, comprising the steps of:
receiving a web page request, the web page request corresponding to a web page comprising cacheable content;
executing a script in response to the web page request, the script comprising a code block corresponding to a content fragment of the web page;
producing a template corresponding to a layout of the web page;
determining whether the content fragment is cacheable;
inserting a key into the template in response to a determination that the content fragment is cacheable, the key identifying the cacheable content fragment;
sending the template to a dynamic proxy cache;
inserting into the web page, by the dynamic proxy cache, the cacheable content fragment identified by the key; and
transmitting the web page comprising the cacheable content fragment.

12. The method according to claim 11, wherein said determining step comprises determining whether the code block comprises a tag indicating that the content fragment is cacheable.

13. The method according to claim 11, wherein the code block comprises a tag indicating cache characteristics of the content fragment, and
wherein said determining step comprises reading the tag to determine the cache characteristics of the content fragment.

14. The method according to claim 13, further comprising the steps of:
executing the code block to generate the content element in response to a determination that the content fragment is non-cacheable; and
inserting the non-cacheable content element into the template.

15. The method according to claim 11, further comprising the step of inserting a command into the template in response to a determination that the content fragment is cacheable, the command instructing the dynamic proxy cache to retrieve the cacheable content fragment.

16. The method according to claim 11, further comprising the steps of:
determining whether the cacheable content fragment is stored in the dynamic proxy cache; and
retrieving the key from a cache directory in response to a determination that the cacheable content fragment is stored in the dynamic proxy cache.

17. The method according to claim 16, further comprising the step of updating the cache directory by releasing the key identifying the cacheable content fragment when the cacheable content fragment becomes invalid.

18. The method according to claim 17, further comprising the step of sending a message to the dynamic proxy cache to remove the invalid content fragment.

19. The method according to claim 16, wherein said step of determining whether the cacheable content fragment is stored in the dynamic proxy cache comprises reading a bit vector associated with the key, the bit vector comprising a bit corresponding to the dynamic proxy cache.

20. The method according to claim 19, further comprising the step of updating the cache directory by releasing the key identifying the cacheable content fragment when the cacheable content fragment becomes invalid.

21. The method according to claim 20, wherein said updating step comprises clearing the bit of the bit vector.

22. The method according to claim 16, further comprising the step of storing the cacheable content fragment in architecture of a web site.

23. The method according to claim 11, further comprising the steps of:
determining whether the cacheable content fragment is stored in the dynamic proxy cache;
executing the code block to generate the cacheable content fragment in response to a determination that the cacheable content fragment is not stored in the dynamic proxy cache;
inserting the cacheable content fragment into the template; and
storing the cacheable content fragment in the dynamic proxy cache after said sending step.

24. The method according to claim 23, further comprising the step of inserting a command into the template, the command instructing the dynamic proxy cache to perform said storing step.

25. The method according to claim 23, further comprising the step of storing the key in a cache directory.

26. The method according to claim 25, further comprising the step of updating the cache directory by releasing the key identifying the cacheable content fragment when the cacheable content fragment becomes invalid.

27. The method according to claim 26, further comprising the step of sending a message to the dynamic proxy cache to remove the invalid cacheable content fragment.

28. A computer-readable medium having computer-executable instructions for performing the method of claim 11.

29. A method for delivering a web page, comprising the steps of:
receiving a web page request;
executing a script in response to the web page request, the script comprising a code block corresponding to a content fragment of the web page;
producing a template at run-time corresponding to a layout of the web page;
assembling the web page according to the template by inserting the content fragment; and
transmitting the web page comprising the content fragment.

30. The method according to claim 29, further comprising the steps of:
determining whether the content fragment is cacheable; and
inserting a key into the template in response to a determination that the content fragment is cacheable, the key identifying the content fragment,
wherein said assembling step comprises inserting into the web page the content fragment identified by the key.

31. The method according to claim 30, further comprising the step of sending the template to a dynamic proxy cache,
wherein the dynamic proxy cache performs said assembling step.

32. The method according to claim 29, further comprising the step of sending the template to a dynamic proxy cache,
wherein the dynamic proxy cache performs said assembling step.

33. The method according to claim 32, further comprising the steps of:
determining whether the content fragment is cacheable; and
inserting a key into the template in response to a determination that the content fragment is cacheable, the key identifying the content fragment,
wherein said assembling step comprises inserting into the web page the content fragment identified by the key.

34. A computer-readable medium having computer-executable instructions for performing the method of claim 29.

35. A method for assigning a key to a cacheable content fragment, the content fragment having a fragment ID, said method comprising the steps of:
determining whether the fragment ID corresponding to the cacheable content fragment exists in a cache directory maintained at a web site, the cache directory comprising information indicating whether the content fragment is stored in a dynamic proxy cache;
assigning a key to the content element in response to a determination that the fragment ID does not exist in the cache directory; and
inserting the key into the cache directory.

36. The method according to claim 35, wherein, in said assigning step, the key is assigned by taking the next available key from a list of keys.

37. The method according to claim 36, further comprising the step of updating the cache directory when the content fragment becomes invalid by releasing the key assigned to the content fragment and inserting the key back into the list of keys.

38. The method according to claim 36, wherein the key comprises an integer, and
wherein the list of keys comprises a free list of unused integers.

39. The method according to claim 35, wherein the cache directory comprises information indicating whether the content fragment is stored in one of a plurality of dynamic proxy caches.

40. The method according to claim 39, wherein the information comprises a bit vector having a plurality of bits, each bit corresponding to a respective one of the plurality of dynamic proxy caches.

41. The method according to claim 40, further comprising the step of updating the cache directory when the content fragment becomes invalid by releasing the key assigned to the content fragment.

42. The method according to claim 41, wherein the key is released in said updating step by clearing each bit of the bit vector.

43. A computer-readable medium having computer-executable instructions for performing the method of claim 35.
